(19) United States
(12) Patent Application Publication
(10) Pub. No.: US 2016/0380873 A1
(43) Pub. Date: Dec. 29, 2016

(54) SHORTEST PATH ROUTING IN SINGLE-CHANNEL NETWORKS WITH AGGREGATING AND NON-AGGREGATING NODES

(71) Applicant: NEC Laboratories America, Inc., Princeton, NJ (US)

(72) Inventors: Konstantinos Kanonakis, New Brunswick, NJ (US); Yawei Yin, Plainsboro, NJ (US); Shinya Nakamura, Tokyo (JP)

(21) Appl. No.: 15/187,074

(22) Filed: Jun. 20, 2016

Related U.S. Application Data
(60) Provisional application No. 62/184,391, filed on Jun. 25, 2015.

(51) Int. Cl. H04L 12/751

(52) U.S. Cl. CPC H04L 45/02

(57) ABSTRACT

Controllers in a software defined network and methods implemented such controllers include forming an auxiliary graph based on a network graph. The network graph includes aggregating and non-aggregating nodes and the auxiliary graph includes a number of non-aggregating nodes based on a number of incoming neighbors to non-aggregating nodes in the network graph. A best path from a source node to a destination node through the auxiliary graph is determined based on output links from non-aggregating nodes are occupied. The best path through the auxiliary graph is translated to a best path from the source node to the destination node through the network graph. Traffic is routed through the software-defined network based on the best path.

### RELATED APPLICATION INFORMATION

This application claims priority to Provisional Application No. 62/184,391, filed on Jun. 25, 2015, incorporated herein by reference in its entirety.

### BACKGROUND

Technical Field

The present invention relates to communication networks and, more particularly, to routing in networks that include aggregating and non-aggregating nodes.

Description of the Related Art

Communication networks that employ all-optical switching technologies provide several beneficial characteristics, including bitrate transparency and low power consumption. However, all-optical networks are more rigid than their electrical counterparts because they generally cannot perform traffic aggregation and switching at fine granularities (e.g., at the packet level). Optical circuits are generally formed that last for a relatively long time. In such a case, traffic arriving at an input port of an optical switch is only directed to a specific output port for as long as the switch configuration lasts.

Electrical switches, on the other hand, can aggregate (or “groom”) traffic originating from multiple sources. This can, for example, take place in the packet domain or in a time-domain multiplexing fashion. Thus, traffic flows originating from a given input port on an electrical switch may be directed to any of the switch's output ports, and traffic from multiple different input ports can be directed to a same output port.

Switching in conventional, electrical switching networks has generally been handled using variations of Dijkstra's algorithm. While similar algorithms exist for routing on networks of non-aggregating nodes, existing solutions for “translucent” networks that include both aggregating nodes and non-aggregating nodes can produce incorrect routing results.

### SUMMARY

A method implemented in a controller used in a software-defined network system includes forming an auxiliary graph based on a network graph. The network graph includes aggregating and non-aggregating nodes and the auxiliary graph includes a number of non-aggregating nodes based on a number of incoming neighbors to non-aggregating nodes in the network graph. A best path from a source node to a destination node through the auxiliary graph is determined based on output links from non-aggregating nodes are occupied. The best path through the auxiliary graph is translated to a best path from the source node to the destination node through the network graph. Traffic is routed through the software-defined network based on the best path.

A controller in a software-defined network includes a routing module that has a processor configured to form an auxiliary graph based on a network graph. The network graph includes aggregating and non-aggregating nodes and the auxiliary graph includes a number of non-aggregating nodes based on a number of incoming neighbors to non-aggregating nodes in the network graph. The processor is further configured to determine a best path from a source node to a destination node through the auxiliary graph based on output links from non-aggregating nodes are occupied and to translate the best path through the auxiliary graph to a best path from the source node to the destination node through the network graph. A node control module is configured to route traffic through the software-defined network based on the best path.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a graph diagram that illustrates a network topology that includes both aggregating nodes and non-aggregating nodes in accordance with the present principles;

FIG. 2 is a block/flow diagram of a method for finding a best path through a network having both aggregating nodes and non-aggregating nodes in accordance with the present principles;

FIG. 3 is a graph diagram that illustrates an auxiliary network topology that corresponds to an original network topology that includes both aggregating nodes and non-aggregating nodes in accordance with the present principles;

FIG. 4 is a block/flow diagram of a method for forming the nodes of an auxiliary graph in accordance with the present principles;

FIG. 5 is a block/flow diagram of a method for forming edges between the nodes of the auxiliary graph in accordance with the present principles;

FIG. 6 is a block/flow diagram of a method of finding a best path through an auxiliary network topology based on the auxiliary graph in accordance with the present principles;

FIG. 7 is a block diagram of a software-defined networking controller in accordance with the present principles; and

FIG. 8 is a block diagram of a processing system in accordance with the present principles.

### DETAILED DESCRIPTION OF PREFERRED EMBODIMENTS

Embodiments of the present invention provide shortest-path routing over hybrid switching topologies that include aggregating and non-aggregating switching nodes. The present embodiments construct an auxiliary topology based on the connectivity between the aggregating and non-aggregating nodes and then perform routing based on non-aggregating node connectivity constraints. The present embodiments further translate the results from the auxiliary topology back to the original network topology. The present embodiments thereby provide unified, single-stage routing over any topology that includes an arbitrary combination of aggregating and non-aggregating switching nodes. In addition, the auxiliary graph structure set forth below need not be modified during network operation, as it is determined by the structure of the original network graph and not by the status of the switching nodes.

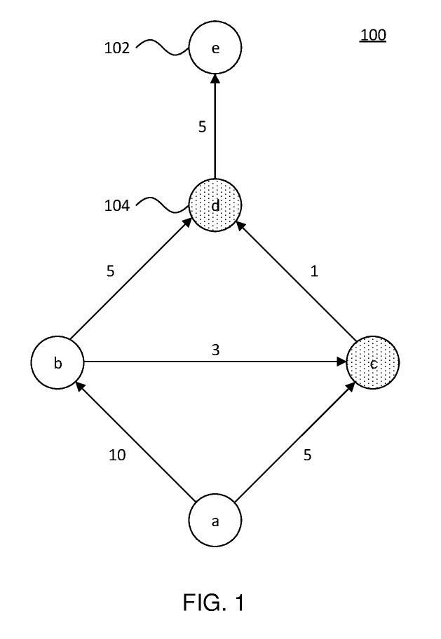

Referring now in detail to the figures in which like numerals represent the same or similar elements and initially to FIG. 1, a graph of a switching network 100 is shown. The network's topology is represented as a directed graph made up of aggregating nodes 102 and non-aggregating nodes 104. Arrows on graph edges indicate a direction of traffic flow and the graph edges are themselves weighted to represent a relative cost of communication between the two connected nodes. The graph of the network 100 is described herein as G=(V, E), where a set of indices V represents the switching nodes 102 and 104 and the set of edges E represents the links between nodes. Referring to a node v indicates the node represented by vertex v in the graph G, while “link(u,v)” indicates a directed link connecting nodes represented by vertices u and v respectively. For the purpose of routing, each link is associated with a non-negative weight value as shown, with the exact meaning of the weight value depending on the particular needs of the network.

The routing problem can be expressed as follows. Given a source node s∈V, find the best path from s to any other node d∈V. The best path is considered to be the path (or paths, in the case of a tie) that minimizes the path length, which is the sum of the weights of the links in the path. To that end, the following definitions are used herein:

weight: A table, where elements weight[u,v] specifies the weight of link(u,v) for each pair of vertices u and v in V. If there is no link between the two vertices, the weight is considered to be infinite.

dist: A vector where the vector element dist[v] indicates the length of the shortest path from the source node s to a target node v.

prev: If a node v is included in the best path from node s toward any other node, then the element prev[v] of the vector prey indicates the node previous to v in the best path, and has an undefined value otherwise.

aggregating: A vector where the element aggregating[v] evaluates to true if the node v has aggregation capabilities and to false otherwise.

occup: A table, where elements occup[u,v] indicate a vertex x if the output port of non-aggregating node u associated with link(u,v) is currently occupied by the input port associated with link(x,u). If the output port is not occupied, weight[u,v] is nil.

original: A vector where the element original[v] indicates vertex u in the original graph to which the vertex v in the auxiliary graph is mapped.

predecessor: A vector where the element predecessor[v] indicates the incoming neighbor of original[v] in the original topology which caused the generation of v in the auxiliary graph.

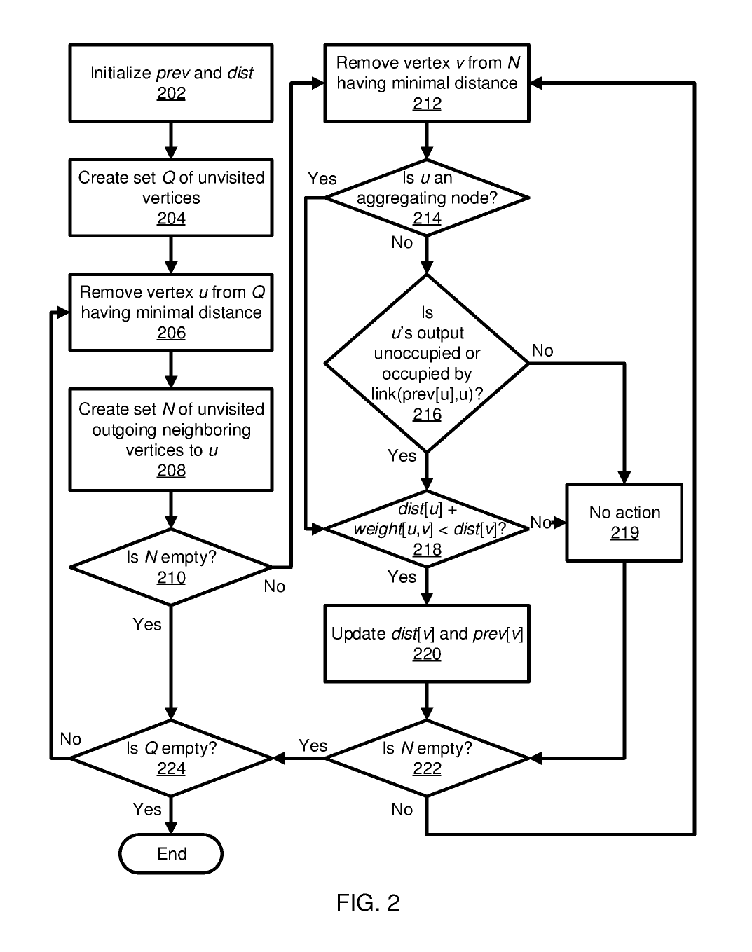

Referring now to FIG. 2, a method of finding a best path from a source node s to a destination node d is shown. Block 202 initializes the prey and dist vectors, with all prey values being set as undefined and the dist value for the source node s being set as 0 and all other dist values being set as infinite. Block 204 creates a new set Q that represents all of the unvisited vertices in the graph G. To begin with, Q is equal to V, the set of all vertices in G. Block 206 selects the vertex u in Q that has the smallest dist value—during the first pass, this will always be the source vertex s—and removes that vertex u from Q. Block 208 creates a set N that is the set of unvisited outgoing neighboring vertices of the node u. This includes all nodes x in Q for which link(u,x) exists.

If the set N is determined to be empty in block 210, block 224 determines whether Q is also empty. If Q is empty, processing ends, otherwise processing returns to block 206 and the next vertex is removed from Q. If N is not empty, block 212 begins a loop that is executed for each of the vertices in N, with an arbitrary vertex v being removed from N by block 212 at each pass.

Block 214 determines whether u is an aggregating node. If not, block 216 determines whether the output of u corresponding to link(u,v) is occupied by the input port of u corresponding to link(prev[u],u). As an alternative, block 216 also determines whether the output of u used by link(u,v) is unoccupied (e.g., occup[u, v]=nil), with the proviso that no other output of u is occupied by prev[u]. If the output of u toward some node x is occupied by prev[u], there is no possibility that link(u,v) can be included in the shortest path, because in this case moving from prev[u] to u would be limited to going toward x due to the current occupancy, rather than to v. This can be expressed as occup[u,v]=nil AND∃/xEV such that: occup[u,x]=prev[u].

If the test of block 216 fails, block 219 takes no action on this node and processing continues to block 222 to determine whether the set N is empty. If block 222 determines that N is not empty, processing returns to block 212 and a next vertex is removed from N. If the test of block 216 succeeds, or if it is determined in block 214 that u is an aggregating node, block 218 determines whether the sum of dist[u] and weight[u,v] (i.e., the length of a new path that includes the existing path and the vertex v) is less than the length of the path to v itself. If not, no action is taken in block 219 as above. If the test of block 218 succeeds, block 220 updates dist[v] to equal dist[u]+weight[u,v] and prev[v] to equal u to ensure that dist[v] remains the shortest path. Block 222 then determines whether the set N is empty and processing continues as described above. If block 222 determines that N is empty, block 224 determines whether Q is also empty, either ending the process and outputting the discovered path or returning to block 206 for consideration of the next unvisited node.

However, the routing process of FIG. 2 may provide incorrect results when applied to the original topology of a network graph. Referring back to FIG. 1, in one example, occup[c,d]=b and all other occupancies for the nodes c and d are undefined. To find the shortest path from a to d, the path indicated to be shortest will be a→b→d→e, having a length of 20. It is clear that a shorter path exists, however, in that a→b→c→d→e has a length of 19. This is because the next node to be selected after a is c and not b, because dist[b]>dist[c]. While examining the neighbors of node c, due to the occupancy of node c, only dist[b] is updated, while dist[d] is not updated and node c is marked as visited. When node b is next selected, only node d is examined among its neighbors, since node c is already marked as visited. As a result, continuing execution leads to the selection of a→b→d→e as the shortest path.

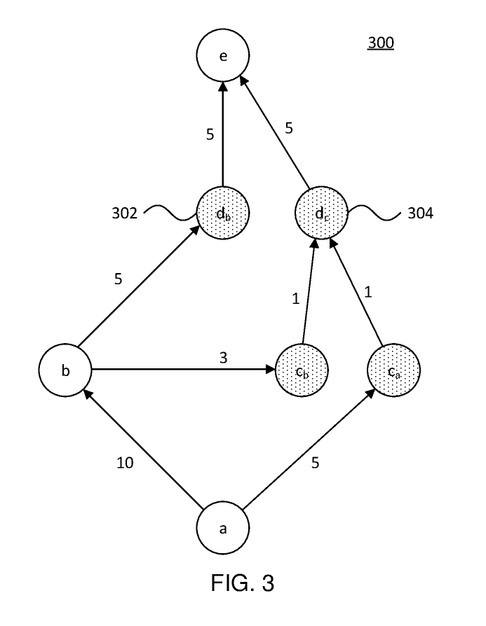

Referring now to FIG. 3, an auxiliary graph 300 is shown that also represents the network but which provides correct results when routing is performed according to FIG. 2. It should be noted that the non-aggregating nodes 104 in the auxiliary graph 300 have been split according to their inputs, for example with the node d being split into d_{b} 302 and d_{c} 304. Similarly the node c is split into c_{b} and cₐ. Following the routing process of FIG. 2 on this auxiliary graph 300 provides the correct best path.

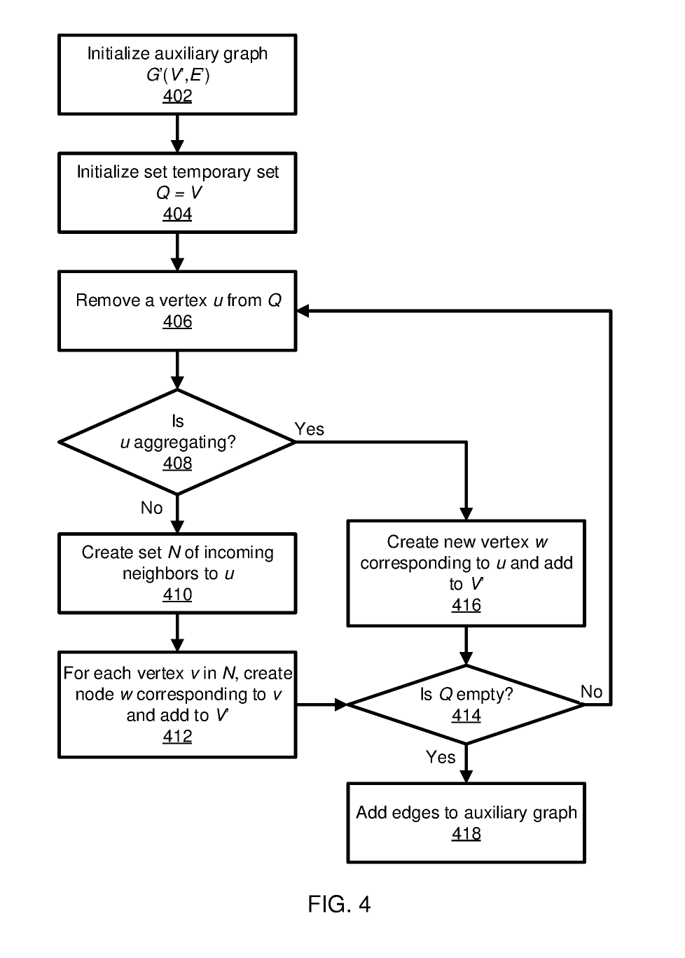

Referring now to FIG. 4, a first stage in building an auxiliary graph is shown. This first stage generates the vertices for the auxiliary topology, while the second stage described below generates the edges of the auxiliary topology. Block 402 creates a new graph G′ defined by a new set of vertices V′ and a new set of edges E′. Block 404 initializes a temporary set of vertices Q that begins with all of the vertices V of the original graph G.

Block 406 begins a loop over the vertices of Q, removing one arbitrary vertex u at a time. Block 408 determines whether u is an aggregating node. If so, block 416 creates a new vertex w that corresponds to u and adds w to the set of vertices V′ of the auxiliary topology. In this case, w is marked as being aggregating and it is associated with u in the original[ ] vector.

If u is not aggregating, block 410 creates a set N of the incoming neighbors to u. For each node v in N, block 412 creates a new vertex w that is added to V′ and is marked as non-aggregating. The new vertex w is associated with u in the original[ ] vector and, in addition, it is marked as having the predecessor v in the predecessor[ ] vector.

After u has been handled, block 414 determines whether any vertices remain in Q. If so, processing returns to block 406 where the next vertex is selected and removed. If not, block 418 creates the edges of the auxiliary graph G′ as described below.

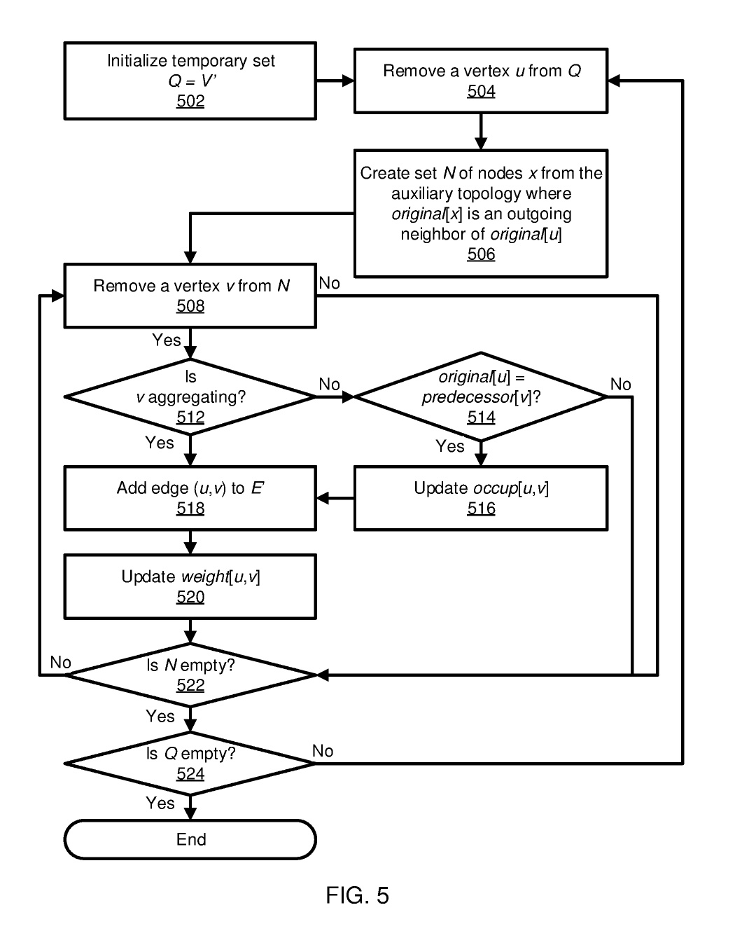

Referring now to FIG. 5, additional detail is provided on the creation of the edges for the auxiliary graph G′ in block 418. Block 502 initializes a new temporary set Q using the set of vertices V′ for the auxiliary graph G′. Block 504 begins a loop by removing a vertex u from Q. For each such vertex u, block 506 creates a set N of using the nodes x from the auxiliary graph G′ where original[x] is an outgoing neighbor of original[u].

If the edge (u,v) does exist in E, block 512 determines whether v is an aggregating node. If so, block 518 adds the edge (u,v) to E′. If not, then block 514 determines whether the vertex corresponding to u in the original graph is the same as the incoming neighbor of node v in the original graph. If not, block 522 determines whether any vertices remain in N. If so, block 516 updates the occupancy of u to reflect the occupancy of the original graph (e.g., occup[u,v]=occup[original[u],original[v]]) and block 518 adds edge (u,v) to E′.

After the edge is added to E′ in block 518, block 520 updates the weight of (u,v) to be the weight of (original[u],original[v]). Block 522 determines whether the set N is empty. If the set N is not empty in any of the above calls of block 522, processing returns to block 508 where a new vertex is removed from N. If N is empty, block 524 determines whether Q is empty. If not, processing returns to block 504 to select a new vertex and start the loop again. If Q is empty, processing ends and the auxiliary graph is complete.

Thus, the output of the processes of FIGS. 4 and 5, when run on the input graph 100 shown in FIG. 1, is the auxiliary graph 300 shown in FIG. 3. Each of the non-aggregating nodes 104 in the original graph 100 results in the creation of a number of non-aggregating nodes equal to the number of incoming neighbors of those nodes (e.g., nodes 302 and 304). Following this example, original[d_{b}]=d and predecessor[d_{b}]=b. For each aggregating node 102 in the original graph 100, a single aggregating node is present in the auxiliary graph 300. If a non-aggregating node were to have no incoming neighbors, that would result in a single non-aggregating node in the auxiliary topology.

For each node u in the auxiliary topology, the links towards its aggregating outgoing neighbors appear according to the links between the original nodes, while a link to a non-aggregating neighbor v appears only if original[u] was the incoming neighbor of original[v] that caused the generation of v (i.e., if original[u]=predecessor[v]). For example, there is a link from node a to node cₐ, but not to node c_{b}.

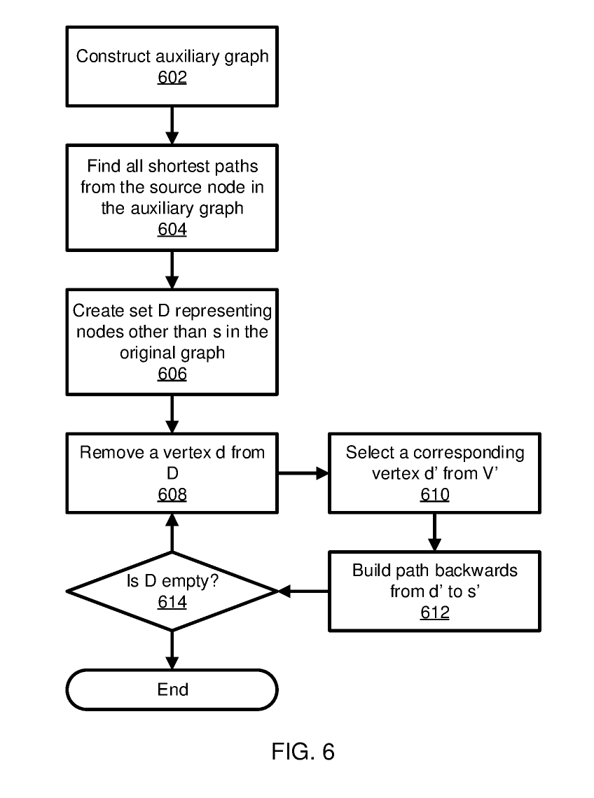

Referring now to FIG. 6, a method for finding the shortest path from an aggregating source node s to any aggregating destination node d on a hybrid network is shown. Block 602 constructs the auxiliary graph G′ as described above in FIGS. 4 and 5. Block 604 finds the shortest paths from the source node s to every other node in the auxiliary graph in block 604 in accordance with the process of FIG. 2. Block 606 creates a set D that includes all nodes other than s from the original graph.

For each node d in D, block 608 removes the node and block 610 selects a corresponding vertex d′ from the set V′ of vertices in the auxiliary graph. Block 612 builds a path backwards from d′ to s′ in the auxiliary topology, with the length of the path to d in the original topology being the same as the length of the path to d′ in the auxiliary topology. If block 614 then determines that D has nodes still, processing returns to block 608 and a next vertex is removed. If D is empty, processing ends and the best path for each node has been found.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

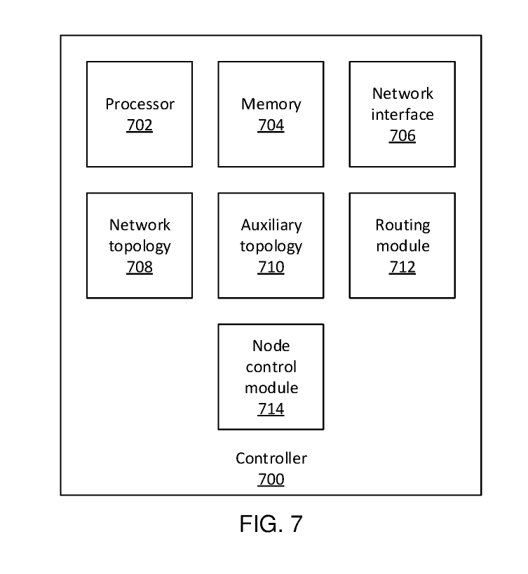

Referring now to FIG. 7, a controller 700 routing in a hybrid network is shown. The controller 700 includes a hardware processor and a memory 704. A network interface enables communication between the controller 700 and nodes in the network as well as providing communications of traffic to be routed. In addition, the controller 700 includes one or more functional modules. In one embodiment the functional modules may be implemented as software that is stored in memory 704 and executed by processor 702. In another embodiment, the functional modules may be implemented as one or more discrete hardware components, for example in the form of an application-specific integrated chip or field programmable gate array.

For example, a routing module 712 uses a network topology 708 that is stored in memory 704 to generate and auxiliary topology 710 as described above. The routing module 712 then determines a best path for a given piece of data from its source node to its destination node. A node control module 714 uses the network interface 706 to control aggregating and non-aggregating nodes in the network to implement the best path.

In this manner, data traffic can be aggregated at select points in the network where electrical switching elements are available. Aggregated traffic originating from an electrical switch or other aggregating node can make use of the all-optical parts of the network until some other de-aggregation point, where it is again converted to the electrical domain and its constituent traffic flows can be switched appropriately. In this manner, a multi-layer network can be centrally controlled as a single network. The controller 700 maintains complete and current network state information by monitoring the states of the individual nodes and their connections in the original topology, with routing module 712 updating the auxiliary topology as needed.

It should be understood that the controller 700 may be a controller in a software-defined networking system. In such a system, the controller 700 interacts with the aggregating and non-aggregating switches to control their switching behavior. This provides the ability to respond to changing network conditions and to rapidly reconfigure the network to response to changing architectural needs.

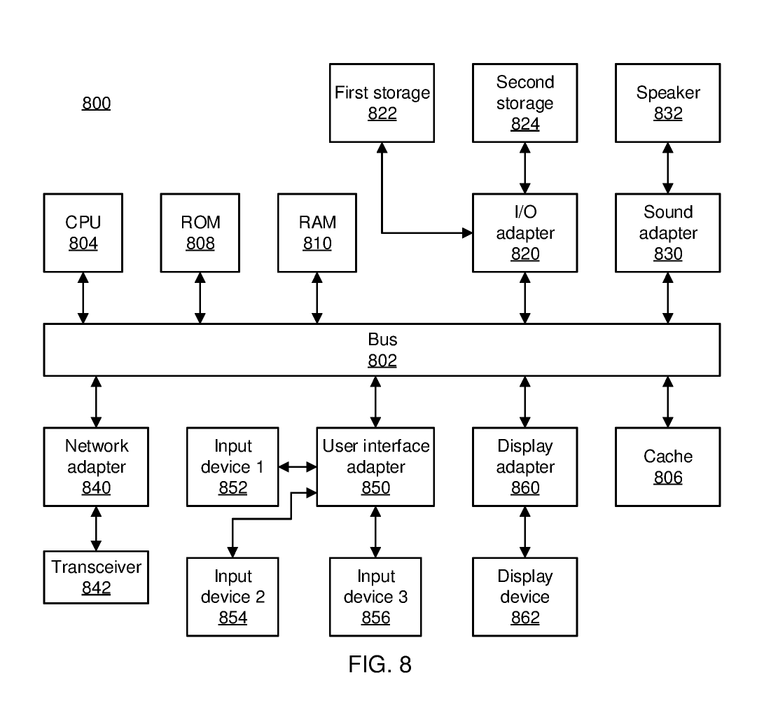

Referring now to FIG. 8, an exemplary processing system 800 is shown which may represent the transmitting device 100 or the receiving device 120. The processing system 800 includes at least one processor (CPU) 804 operatively coupled to other components via a system bus 802. A cache 806, a Read Only Memory (ROM) 808, a Random Access Memory (RAM) 810, an input/output (I/O) adapter 820, a sound adapter 830, a network adapter 840, a user interface adapter 850, and a display adapter 860, are operatively coupled to the system bus 802.

A first storage device 822 and a second storage device 824 are operatively coupled to system bus 802 by the I/O adapter 820. The storage devices 822 and 824 can be any of a disk storage device (e.g., a magnetic or optical disk storage device), a solid state magnetic device, and so forth. The storage devices 822 and 824 can be the same type of storage device or different types of storage devices.

A speaker 832 is operatively coupled to system bus 802 by the sound adapter 830. A transceiver 842 is operatively coupled to system bus 802 by network adapter 840. A display device 862 is operatively coupled to system bus 802 by display adapter 860.

A first user input device 852, a second user input device 854, and a third user input device 856 are operatively coupled to system bus 802 by user interface adapter 850. The user input devices 852, 854, and 856 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 852, 854, and 856 can be the same type of user input device or different types of user input devices. The user input devices 852, 854, and 856 are used to input and output information to and from system 800.

Of course, the processing system 800 may also include other elements (not shown), as readily contemplated by one of skill in the art, as well as omit certain elements. For example, various other input devices and/or output devices can be included in processing system 800, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 800 are readily contemplated by one of ordinary skill in the art given the teachings of the present principles provided herein.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method implemented in a controller used in a software-defined network system, the method comprising:
forming an auxiliary graph based on a network graph that comprises aggregating and non-aggregating nodes, the auxiliary graph comprising a number of non-aggregating nodes based on a number of incoming neighbors to non-aggregating nodes in the network graph;
determining a best path from a source node to a destination node through the auxiliary graph based on output links from non-aggregating nodes are occupied;
translating the best path through the auxiliary graph to a best path from the source node to the destination node through the network graph; and
routing traffic through the software-defined network based on the best path.

2. The method of claim 1, wherein forming the auxiliary graph comprises creating a new non-aggregating node in the auxiliary graph for each incoming neighbor of each non-aggregating node in the network graph.

3. The method of claim 1, wherein forming the auxiliary graph comprises creating a single new non-aggregating node in the auxiliary graph for each non-aggregating node in the network graph that has no incoming neighbors.

4. The method of claim 1, wherein forming the auxiliary graph comprises creating a single new aggregating node in the auxiliary graph for each aggregating node in the network graph.

5. The method of claim 1, wherein forming the auxiliary graph comprises creating edges from any node to a non-aggregating node in the auxiliary graph based on an occupancy status of a corresponding non-aggregating node in the network graph.

6. The method of claim 1, wherein forming the auxiliary graph comprises creating edges from any node to an aggregating node in the auxiliary graph if an edge between corresponding nodes in the network graph exists.

7. A controller in a software-defined network, comprising:
a routing module comprising a processor configured to form an auxiliary graph based on a network graph that comprises aggregating and non-aggregating nodes, the auxiliary graph comprising a number of non-aggregating nodes based on a number of incoming neighbors to non-aggregating nodes in the network graph; to determine a best path from a source node to a destination node through the auxiliary graph based on output links from non-aggregating nodes are occupied; and to translate the best path through the auxiliary graph to a best path from the source node to the destination node through the network graph; and
a node control module configured to route traffic through the software-defined network based on the best path.

8. The controller of claim 7, wherein the routing module is further configured to create a new non-aggregating node in the auxiliary graph for each incoming neighbor of each non-aggregating node in the network graph.

9. The controller of claim 7, wherein the routing module is further configured to create a single new non-aggregating node in the auxiliary graph for each non-aggregating node in the network graph that has no incoming neighbors.

10. The controller of claim 7, wherein the routing module is further configured to create a single new aggregating node in the auxiliary graph for each aggregating node in the network graph.

11. The controller of claim 7, wherein the routing module is further configured to create edges from any node to a non-aggregating node in the auxiliary graph based on an occupancy status of a corresponding non-aggregating node in the network graph.

12. The controller of claim 7, wherein the routing module is further configured to create edges from any node to an aggregating node in the auxiliary graph if an edge between corresponding nodes in the network graph exists.
